(19) United States
(12) Patent Application Publication
(10) Pub. No.: US 2008/0282991 A1
(43) Pub. Date: Nov. 20, 2008

(54) COIN-OPERATED DOG CRATE

(76) Inventor: Suzan Kimberly Krasoff, San Diego, CA (US)

Correspondence Address: ATTN: NEIL K. NYDEGGER, NYDEGGER & ASSOCIATES, 348 Olive Street, San Diego, CA, 92103, US

(21) Appl. No.: 12/122,382

(22) Filed: May 16, 2008

Related U.S. Application Data
(60) Provisional application No. 60/938,625, filed on May 17, 2007.

(51) Int. Cl. A01K 1/03; G07F 17/10

(52) U.S. Cl. 119/456; 119/452; 119/475; 194/353

(57) ABSTRACT

A temporary dog-confining device is provided for public use. Structurally, the device includes an enclosure formed from front, rear, and opposed side walls. For use, the rear and side walls are covered with screens to provide shade in the enclosure. Further, the enclosure includes a roof covered with a canopy for shading the enclosure. Also, the front wall defines an opening that is selectively closed by a door. In order to secure a dog within the enclosure, the device includes an assembly for locking the door in a closed configuration. Specifically, the locking assembly is operable by a user after a required payment. Moreover, the device includes a separately-accessible compartment mounted within the enclosure to house a fluid container for providing water to a dog in the enclosure. Importantly, that compartment is secured by a fastener that is operated independently of the locking assembly.

This application claims the benefit of U.S. Provisional Patent Application Ser. No. 60/938,625, filed May 17, 2007.

### FIELD OF THE INVENTION

The present invention pertains generally to secured enclosures. More particularly, the present invention pertains to devices and methods for providing securable enclosures for temporarily holding dogs or other pets in public areas. The present invention is particularly, but not exclusively, useful as a public device and method that safely confines a pet in an enclosure while limiting access to the enclosure to the pet owner.

### BACKGROUND OF THE INVENTION

Increasingly, pets, particularly dogs, accompany their owners during errands to stores and on longer outings. While some stores and public areas welcome dogs, others require that they be tied or otherwise restrained in designated or undesignated areas. As a result, dogs are often left unattended, tied to a tree or bike rack outside a store. However, such unattended dogs may be targeted for theft, particularly for resale purposes. Often, such theft is particularly remunerative. In fact, on the open market, purebred dogs can sell for up to $5,000. In step with the market for dogs, the rate of theft of dogs has grown. Reportedly, over one million dogs are stolen each year and only about ten percent are found. As a result of the rise in dog theft, private dog finder agencies have even been established.

In addition to the problem of theft of unattended dogs, dogs that are tied up outside of stores or similar public areas may present a nuisance to other people. This is particularly true when a large number of dogs are leashed and unattended in a common area. Further, dogs tied outside of stores may suffer from overheating in unshaded areas.

In light of the above, it is an object of the present invention to provide a temporary dog-confining device for public use. More specifically, it is an object of the invention to provide a device that shelters a dog in a secured enclosure. Another object of the present invention is to provide a dog-confining device that is coin-operated. Still another object of the present invention is to provide a dog-confining device that is available for public use and that includes a secure water source. Yet another object of the present invention is to provide a coin-operated dog enclosure and method for use that is easy to implement, is simple to use, and is comparatively cost effective.

### SUMMARY OF THE INVENTION

In accordance with the present invention, a device is provided to temporarily house and confine a pet, such as a dog, at a public area. In practice, a plurality of the devices may be provided at grocery stores, restaurants, retail stores, museums, and the like to allow dog owners to enter the public areas without their dogs.

Structurally, the device includes an enclosure that is formed from opposed front and rear walls, opposed side walls, and a roof. Preferably, the walls and roof are formed from a collapsible cage created with six and nine gauge wire. In order to provide access to the interior of the enclosure for a dog, the front wall defines an opening. Also, the device includes a door for closing the opening to confine a dog within the enclosure. In addition to the opening on the front wall, a side wall is provided with an opening to allow for access by a person. Specifically, the opening on the side wall allows the interior of the enclosure to be cleaned and water or food to be re-supplied. Preferably, the opening on the side wall is closed by a lockable door made from six and nine gauge wire.

For purposes of the present invention, the device includes a locking assembly for securing the closed door. Structurally, the locking mechanism is mounted on the front wall of the enclosure and engages the door to secure the door in its closed configuration. Further, the locking assembly includes a controller that receives a payment, locks the locking mechanism, and provides a key, check, code or other input to the dog owner. Preferably, the controller is coin-, bill- or debit or credit card-activated.

In order to provide safe conditions for a dog confined within the device, the device is provided with at least one solar screen to provide shade within the enclosure. Preferably, a solar screen is provided on each side wall and on the rear wall of the device. Further, the roof is provided with a canopy to provide shade and to provide protection from precipitation or from debris from other enclosures stacked above the device. Also, the device includes a compartment mounted to the rear wall and inside the enclosure to hold a water bladder to provide water to a dog in the enclosure. Preferably, the compartment is comprised of a cage created with seven gauge wire that hangs from the top panel and is secured to the two side panels. Moreover, the compartment is secured by a lock to prevent unauthorized access to the water bladder in the compartment. Preferably, the water bladder is a heavy duty, rubber or plastomeric, gravity-fed or self-fed container that is hung from the top panel of the compartment. Further, the bladder is connected to a nozzle which feeds water into a dish positioned in the enclosure, as is known in the art.

For use, a dog-confining device is located in a public area by a manager. The manager positions a water bladder in the compartment and secures the closed compartment with a fastener to prevent contamination of the water bladder. Thereafter, a dog owner may place a dog in the enclosure and make a payment to the locking assembly to lock the door in its closed configuration. At that time, the locking assembly provides the dog owner with a key, check or code. When the dog owner is ready to leave the public area, the key, check or code is entered into the locking assembly to unlock the door. Thereafter, the device is free for use by others.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front perspective view of a dog-confining device in accordance with the present invention;

FIG. 2 is a plan view of an assembly for locking the dog-confining device of FIG. 1;

FIG. 3 is a rear perspective view of the dog-confining device of FIG. 1, shown with a canopy and sunscreen; and

FIG. 4 is a cross sectional view of the dog-confining device of FIG. 3, taken along line 4-4 in FIG. 3.

### DESCRIPTION OF THE PREFERRED EMBODIMENTS

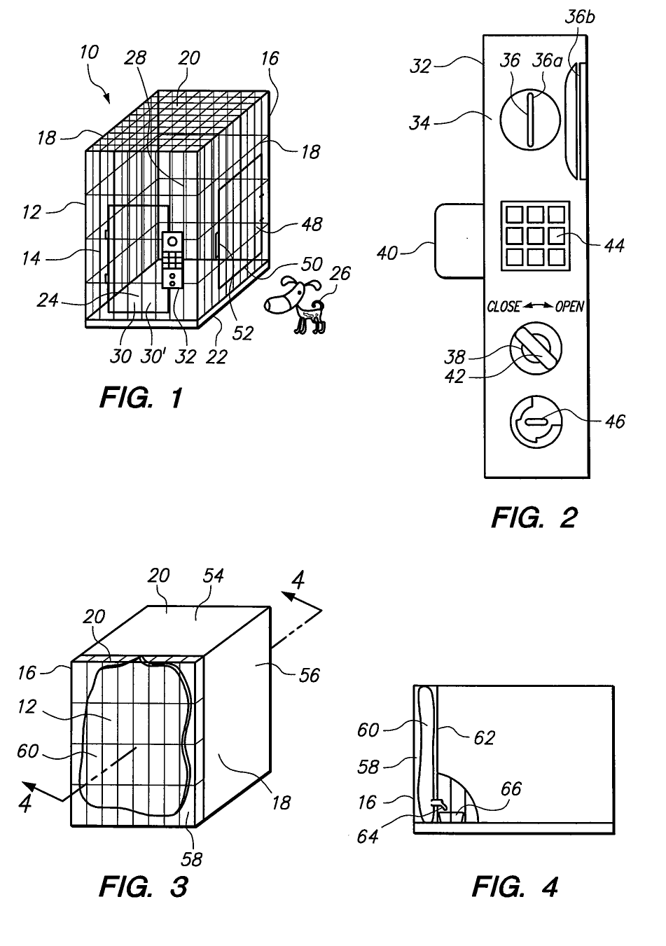

Referring initially to FIG. 1, a dog-confining device is shown and generally designated 10. As shown in FIG. 1, device 10 includes a shelter or enclosure 12 that has a front wall 14, a rear wall 16, opposed side walls 18, a roof 20, and a floor 22. Preferably, the walls 14, 16, 18 and roof 20 are formed from a collapsible cage created with six and nine gauge wire. As shown in FIG. 1, the front wall 14 forms an opening 24 for allowing a dog 26 to enter and exit the interior 28 of the enclosure 12. Further, the device 10 includes a door 30 for closing the opening 24 to confine the dog 26 within the enclosure 12. In FIG. 1, the door 30 is shown in its closed configuration 30′.

Still referring to FIG. 1, it can be seen that the device 10 includes an assembly 32 for locking the door 30 in the closed configuration 30′. Specifically, the locking assembly 32 is positioned on the front wall 14 adjacent the opening 24. Referring to FIG. 2, the features of the locking assembly 32 may be understood. As shown in FIG. 2, the locking assembly 32 has an interface 34 that includes a payment mechanism 36 such as a coin slot 36a or a credit/debit card reading unit 36b. Further, the interface 34 includes a component 38 for activating or deactivating the locking assembly 32. Specifically, the component 38 is used to advance a bolt 40 into engagement with the door 30, or to withdraw the bolt 40 from engagement with the door 30. Further, the locking assembly 32 provides the user with the ability to unlock the door 30. For instance, the key 42 may be removable upon locking the door 30. After use of the device 10 is finished, the key 42 may be reinserted into the interface 34 to cause the component 38 to deactivate the locking assembly 32. Alternatively, the user may set a code through input into the interface 34 through a keypad 44, and then reenter the code when use of the device 10 is finished. Also, the user may receive a check or other device that allows the user to unlock the door 30 after use. As shown in FIG. 2, the interface 34 also includes a keyhole 46 for receiving a master key to override the locking assembly 32 if necessary.

Referring back to FIG. 1, it can be seen that the enclosure 12 further includes a side opening 48 in a side wall 18 providing access to the interior 28. Specifically, the side opening 48 allows a store owner or manager with responsibility for the device 10 to clean the interior 28 of the enclosure 12. As shown, the side opening 48 is closed by a door 50 having a lock 52 accessible by owner or manager of the device 10.

Referring now to FIG. 3, the device 10 is shown to include a canopy 54 positioned over the roof 20 to provide shade and protection from precipitation or debris. Further, the device 10 is provided with solar screens 56 on the side walls 18 and rear wall 16 to further shade the enclosure 12.

Still referring to FIG. 3, it may be seen that the device 10 includes a compartment 58 mounted to the rear wall 16 of the enclosure 12. As shown, the compartment 58 houses a water bladder 60 to safely provide water to a dog 26 within the enclosure 12. Preferably, the water bladder 60 is a heavy duty, rubber or plastomeric, gravity-fed or self-fed container that is hung from the top of the compartment 58.

Cross-referencing FIG. 3 with FIG. 4, it may be seen that the compartment 58 is separated from the rest of the enclosure 12 by a gate 62 that connects to the side walls 18 and roof 20. Preferably, the gate 62 is comprised of a cage created with seven gauge wire. Moreover, the gate 62 is preferably secured by a lock to prevent unauthorized access to the compartment 58. As a result, it is ensured that the water bladder 60 is uncontaminated. As shown in FIG. 4, the water bladder 60 is connected to a nozzle 64 that may directly feed a dog 26, or fill a dish 66 with water.

In order to provide the public with the ability to safely shelter dogs 26 while shopping, eating or otherwise enjoying a public area, a plurality of devices 10 may be stationed at desired areas by a store owner or manager. For each device 10, the owner or manager will position a water bladder 60 in the respective compartment 58 and secure the gate 62. Further, the owner or manager will clean the enclosure 12 and lock the side opening 48. Thereafter, each device 10 is available for use by the public. Specifically, a dog owner may place a dog 26 in the enclosure 12 and make a payment to the locking assembly 32 to lock the door 30 in its closed configuration 30′. Depending on the desired operation, the dog owner may be provided with a key 42, code or other check to unlock the door 30. After the key 42, check or code is entered and the door 30 is unlocked, the device 10 may be used by another dog owner.

While the particular Coin-operated Dog Crate as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A temporary dog-confining device for public use comprising:
an enclosure forming an opening, wherein said enclosure defines a space for holding a dog;
a door for closing the opening;
an assembly for locking the door in closed configuration; and
an interface for receiving a payment from a user, wherein after the payment is received the interface allows the user to lock the door a single time and thereafter to unlock the door.

2. A device as recited in claim 1 wherein the enclosure is formed with opposed front and rear walls, opposed side walls, and a roof, and wherein the front wall defines the opening.

3. A device as recited in claim 2 further comprising a canopy connected to the roof for providing shade in the enclosure.

4. A device as recited in claim 4 further comprising a side screen connected to at least one side wall for providing shade in the enclosure.

5. A device as recited in claim 4 further comprising a compartment mounted to the rear wall, with the compartment positioned within the enclosure to house a fluid container for providing water to a dog in the enclosure.

6. A device as recited in claim 5 further comprising a fastener for securing the compartment to prevent contamination of the fluid container.

7. A device as recited in claim 5 wherein the fluid container is a fluid bladder suspended from the compartment.

8. A device as recited in claim 1 further comprising a compartment mounted within the enclosure to house a fluid container for providing water to a dog in the enclosure.

9. A device as recited in claim 8 further comprising a fastener for securing the compartment to prevent contamination of the fluid container.

10. A temporary dog-confining device for public use comprising:
a means for enclosing a space for holding a dog;
a means for providing access to the enclosed space;
a means for securing the enclosed space upon receipt of a payment; and
a means for unsecuring the enclosed space upon receipt of an input.

11. A device as recited in claim 10 wherein the enclosing means includes an enclosure forming an opening, wherein said enclosure defines the space and an opening formed in the enclosure provides access to the enclosed space.

12. A device as recited in claim 11 wherein a door is provided to close the opening and wherein an assembly for locking the door in a closed configuration is provided to secure the enclosed space upon receipt of a payment.

13. A device as recited in claim 12 further comprising a means for providing shelter and shade to the enclosed space.

14. A device as recited in claim 13 further comprising a means for providing drinking water in the enclosed space, and a means for preventing tampering of the drinking water.

15. A device as recited in claim 14 wherein the providing means comprises a compartment mounted within the enclosure to house a fluid container for providing water to a dog in the enclosure, and wherein the preventing means comprises a fastener for securing the compartment to prevent contamination of the fluid container.

16. A device as recited in claim 15 wherein the fluid container is a fluid bladder suspended from the compartment.

17. A method of facilitating use of a public area by dog owners comprising the steps of:
positioning a plurality of dog-confining devices at the public area for use by dog owners, with each device comprising an enclosure defining an opening, a door for closing the opening, an assembly for locking the door, with the assembly being operable by a user after payment to selectively lock the door in a closed configuration, and a compartment mounted within the enclosure;
mounting a fluid container in each compartment to provide water to a dog in each enclosure; and
locking each compartment to prevent contamination of each fluid container.

18. A method as recited in claim 17 further comprising the steps of:
establishing a unique key for the user to input into the locking assembly after payment; and
requiring input of the unique key to unlock the door.

19. A method as recited in claim 17 wherein the enclosure is formed from with opposed front and rear walls, opposed side walls, and a roof, wherein the front wall defines the opening, and wherein the method further comprises the steps of:
connecting a canopy to the enclosure of each device to provide shade therein; and
connecting a solar screen to the rear wall and to the side walls of each device to provide shade in the enclosure.

20. A method as recited in claim 19 wherein the fluid container is a fluid bladder and wherein the mounting step is accomplished by suspending the bladder from the compartment.
